(19) United States
(12) Patent Application Publication
(10) Pub. No.: US 2026/0016142 A1
(43) Pub. Date: Jan. 15, 2026

(54) PANEL LIGHT

(71) Applicant: Xiamen PVTECH Co., Ltd., Xiamen (CN)

(72) Inventors: SISHAN LIAO, Xiamen (CN); LIANGLIANG CAO, Xiamen (CN); YANLING XIAO, Xiamen (CN); WEIBIAO ZHONG, Xiamen (CN); HAIBO HONG, Xiamen (CN); DEJIA LI, Xiamen (CN); JINSHENG LI, Xiamen (CN)

(73) Assignee: Xiamen PVTECH Co., Ltd., Xiamen (CN)

(21) Appl. No.: 19/332,016

(22) Filed: Sep. 17, 2025

Related U.S. Application Data
(63) Continuation-in-part of application No. 19/057,950, filed on Feb. 19, 2025.

(30) Foreign Application Priority Data
Jul. 12, 2024 (CN) 202410937559.0
Jul. 12, 2024 (CN) 202410937560.3
Jul. 12, 2024 (CN) 202410937562.2
Jul. 12, 2024 (CN) 202421653247.9
Jul. 12, 2024 (CN) 202421653251.5
Oct. 21, 2024 (CN) 202422542674.6

(51) Int. Cl. F21V 17/16; F21S 8/04; F21S 8/06; F21V 15/01; F21V 17/10; F21V 23/00; F21Y 105/10; F21Y 115/10

(52) U.S. Cl. CPC F21V 17/164; F21S 8/043; F21S 8/061; F21V 15/01; F21V 17/101; F21V 23/002; F21Y 2105/10; F21Y 2115/10

(57) ABSTRACT

A panel light includes a frame body, a back plate, a plurality of light sources and a light cover. The frame body has an opening. The back plate is disposed within the frame body via the opening, and the back plate has a light exit. The light sources are disposed within the back plate via the light exit. The light cover is disposed on the frame body and covers the light sources. The light cover has a light entrance connected to the light exit. The area of the light entrance is greater than the area of the light exit.

### CROSS REFERENCE TO RELATED APPLICATIONS

This application is a continuation-in-part of U.S. application Ser. No. 19/057,950, filed on Feb. 19, 2025. The content of the application is incorporated herein by reference.

### BACKGROUND OF THE INVENTION

### 1. Field of the Invention

The present invention is related to a light, in particularly, to a panel light.

### 2. Description of the Prior Art

Some currently available panel lights are mounted on the ceiling via a ceiling-mounted frame. However, such mounting structures are bulky and heavy, resulting in low installation efficiency and negatively affecting the appearance of the panel light. Besides, the high cost of these mounting structures significantly limits the application of panel lights.

Some other currently available panel lights can be installed on the ceiling using a mounting structure that includes a carrier plate and hooks. While this mounting structure improves the appearance compared to ceiling-mounted lights, the installation process is relatively complex, leading to low installation efficiency. Furthermore, this mounting structure lacks sufficient safety.

Additionally, some currently available panel lights can be installed on the ceiling via a metal frame with multiple mounting holes. However, this mounting structure requires several people to complete the installation process, thereby increasing labor costs. Moreover, this structure also affects the appearance of the panel lights.

Further, most currently available frameless panel lights adopt a narrow-frame structure. This structure is achieved by reducing the frame size, but the light emitted by the panel light can still be easily obstructed by the frame.

Some currently available frameless panel lights feature side light-emitting function, but the structure required to achieve this is relatively complex, significantly increasing costs. Moreover, this structure can also lead to luminous flux loss, making it difficult to achieve high luminous efficiency.

### SUMMARY OF THE INVENTION

One embodiment of the present invention provides a panel light, which includes a frame body, a back plate, a plurality of light sources and a light cover. The frame body has an opening. The back plate is disposed within the frame body via the opening, and the back plate has a light exit. The light sources are disposed within the back plate via the light exit. The light cover is disposed on the frame body and covers the light sources. The light cover has a light entrance connected to the light exit. The area of the light entrance is greater than the area of the light exit.

The panel light in accordance with the embodiments of the present invention may have the following advantages:
(1) In one embodiment of the present invention, the panel light includes a frame body, a back plate, a plurality of light sources and a light cover. The frame body has an opening. The back plate is disposed within the frame body via the opening, and the back plate has a light exit. The light sources are disposed within the back plate via the light exit. The light cover is disposed on the frame body and covers the light sources. The light cover has a light entrance connected to the light exit. The area of the light entrance is greater than the area of the light exit. Via this special optical structure design, a bottom surface of the light cover forms a first light-emitting surface while a side wall of the light cover forms a second light-emitting surface. The first light-emitting surface serves as a front light-emitting surface, and the second light-emitting surface serves as a side light-emitting surface. Thus, the panel light not only has front light-emitting function but also side light-emitting function, increasing the overall light-emitting area of the panel light and significantly enhancing luminous flux. Consequently, the luminous efficacy of the panel light can be effectively improved, substantially boosting the overall performance of the panel light. Additionally, the panel light can achieve a frameless appearance for great visual effects.
(2) In an embodiment of the present invention, the panel light has a special optical structure design that enables both front light-emitting function and side light-emitting function. Therefore, the luminous efficacy of the panel light can be effectively improved, allowing the panel light to reduce energy consumption while simultaneously lowering carbon emissions. Thus, the panel light can truly meet energy-saving requirements.
(3) In an embodiment of the present invention, the outer edge of the frame body of the panel light has a fixing channel and a fixing post. The fixing post is disposed within the fixing channel such that the cross-section of the fixing channel is U-shaped. Via this fixing channel structure design, the light cover can be mounted on the frame body and fixed thereto via a simple screw-free fastening structure. Consequently, structural complexity of the panel light can be significantly reduced, lowering the cost thereof. Simultaneously, the manufacturing process of the panel light can be substantially simplified, reducing the production costs thereof. Therefore, the panel light can be more comprehensive in application.
(4) In an embodiment of the present invention, the outer edge of the frame body of the panel light has the fixing channel and the fixing post. The fixing post is disposed within the fixing channel such that the cross-section of the fixing channel is U-shaped. Via this fixing channel structure design, the fixing channel can not only achieve a snap-fit fastening structure but also simultaneously function as both an adhesive groove and an adhesive overflow groove to realize an adhesive fastening structure. Thus, the manufacturing process of the panel light can be more flexible to meet different application requirements.
(5) In an embodiment of the present invention, the outer edge of the frame body of the panel light has the fixing channel and the fixing post. The fixing post is disposed within the fixing channel such that the cross-section of the fixing channel is U-shaped. Via this fixing channel structure design, the light cover can be mounted on the frame body and fixed thereto via various fastening methods including but not limited to a snap-fit structure, ultrasonic welding, or an adhesive bonding structure. Therefore, the user can select suitable fastening methods according to actual needs, making the panel light better conform to actual requirements.

Further scope of applicability of the present application will become more apparent from the detailed description given hereinafter. However, it should be understood that the detailed description and specific examples, while indicating exemplary embodiments of the present invention, are given by way of illustration only, since various changes and modifications within the spirit and scope of the present invention will become apparent to those skilled in the art from this detailed description.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

The present invention will become more fully understood from the detailed description given herein below and the accompanying drawings which are given by way of illustration only, and thus are not limitative of the present invention and wherein:

FIG. 1 is a perspective view of a panel light in accordance with a first embodiment of the present invention.

FIG. 2 is a first schematic view of the panel light in accordance with the first embodiment of the present invention.

FIG. 3 is a second schematic view of the panel light in accordance with the first embodiment of the present invention.

FIG. 4 is a sectional view of the panel light in accordance with the first embodiment of the present invention.

FIG. 5 is a partial enlargement view of the panel light in accordance with the first embodiment of the present invention.

FIG. 6 is a first partial enlargement view of the panel light in accordance with a second embodiment of the present invention.

FIG. 7 is a second partial enlargement view of the panel light in accordance with the second embodiment of the present invention.

FIG. 8 is an exploded view of a panel light in accordance with a third embodiment of the present invention.

FIG. 9 is a perspective view of the panel light in accordance with the third embodiment of the present invention.

FIG. 10 is a sectional view of a lamp body of the panel light in accordance with the third embodiment of the present invention.

FIG. 11 is a partial enlargement view of the panel light in accordance with the third embodiment of the present invention.

FIG. 12 is a partial enlargement view of a carrier plate of the panel light in accordance with the third embodiment of the present invention.

FIG. 13 is a perspective view of the carrier plate of the panel light in accordance with the third embodiment of the present invention.

FIG. 14 is a schematic view of a combination of the carrier plate and a junction box of the panel light in accordance with the third embodiment of the present invention.

FIG. 15 is a first schematic view of an installation process of the panel light in accordance with the third embodiment of the present invention.

FIG. 16 is a second schematic view of the installation process of the panel light in accordance with the third embodiment of the present invention.

FIG. 17 is a third schematic view of the installation process of the panel light in accordance with the third embodiment of the present invention.

FIG. 18 is a fourth schematic view of the installation process of the panel light in accordance with the third embodiment of the present invention.

FIG. 19 is an exploded view of a panel light in accordance with a fourth embodiment of the present invention.

FIG. 20 is a front view of a supporting plate of the panel light in accordance with the fourth embodiment of the present invention.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing. It should be understood that, when it is described that an element is “coupled” or “connected” to another element, the element may be “directly coupled” or “directly connected” to the other element or “coupled” or “connected” to the other element through a third element. In contrast, it should be understood that, when it is described that an element is “directly coupled” or “directly connected” to another element, there are no intervening elements.

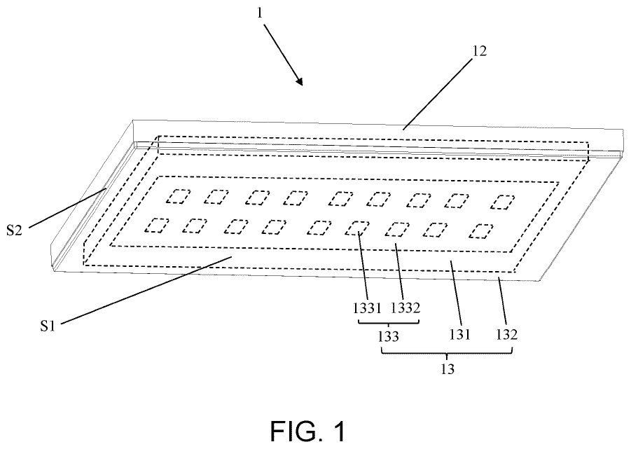

Please refer to FIG. 1, which is a perspective view of a panel light in accordance with a first embodiment of the present invention. As shown in FIG. 1, the panel light 1 includes a frame body 12 and a lamp body 13. The lamp body 13 includes a back plate 131, a light cover 132, and a light source board 133. The light source board 133 includes a circuit board 1332 and a plurality of light sources 1331. In another embodiment, the light source board 133 may be replaced with light bulbs, fluorescent tubes, or other currently available light sources.

The lamp body 13 is disposed within the frame body 12, and the light cover 132 is disposed on the frame body 12 and covers the light sources 1331.

The embodiment just exemplifies the present invention and is not intended to limit the scope of the present invention; any equivalent modification and variation according to the spirit of the present invention is to be also included within the scope of the following claims and their equivalents.

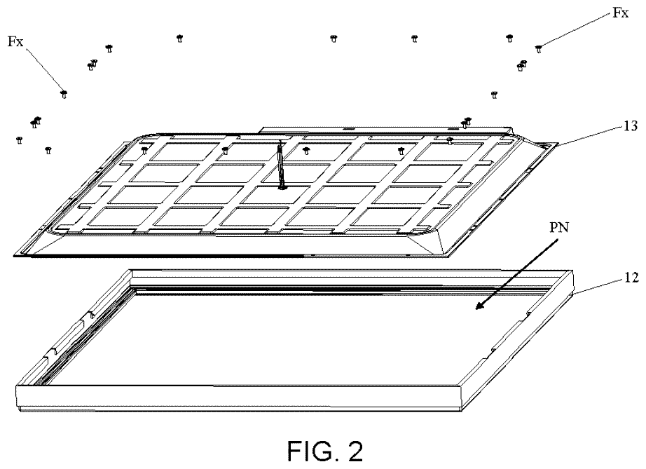

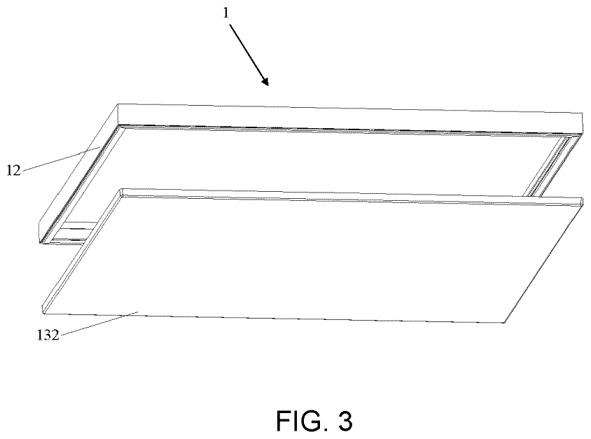

Please refer to FIGS. 2 and 3. FIG. 2 is a first schematic view of the panel light in accordance with the first embodiment of the present invention. FIG. 3 is a second schematic view of the panel light in accordance with the first embodiment of the present invention. As shown in FIG. 2, the frame body 12 has an opening PN. First, a user can place the lamp body 13 into the frame body 12 through the opening PN, then fix the lamp body 13 within the frame body 12 using several fixation elements Fx.

As shown in FIG. 3, the user can then install the light cover 132 onto the frame body 12 and fix the light cover 132 to the frame body 12, such that the light cover 132 can cover the light sources 1331.

The embodiment just exemplifies the present invention and is not intended to limit the scope of the present invention; any equivalent modification and variation according to the spirit of the present invention is to be also included within the scope of the following claims and their equivalents.

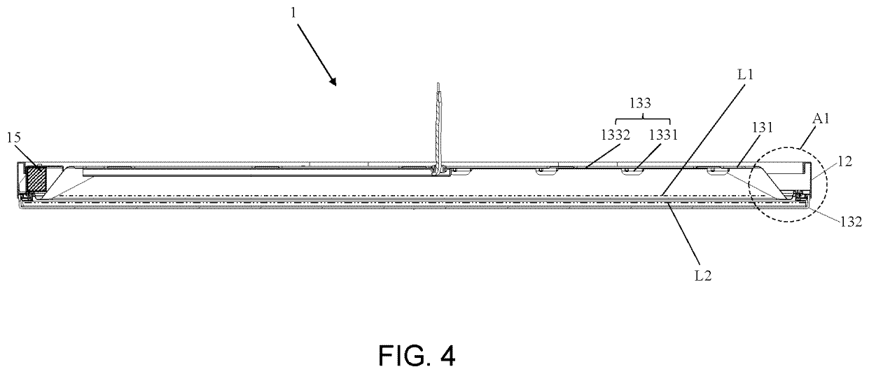

Please refer to FIG. 4, which is a sectional view of the panel light in accordance with the first embodiment of the present invention. Please also refer to FIG. 1, FIG. 2 and FIG. 3. As shown in FIG. 4, the back plate 131 is disposed within the frame body 12 through the opening PN. The back plate 131 has a light exit L1 (shown as the area indicated by a one-dot chain line in FIG. 4), and the light sources 1331 are disposed within the back plate 131 through the light exit L1. In this embodiment, the light sources 1331 may be light-emitting diodes (LEDs). In another embodiment, the multiple light sources 1331 may be LED arrays.

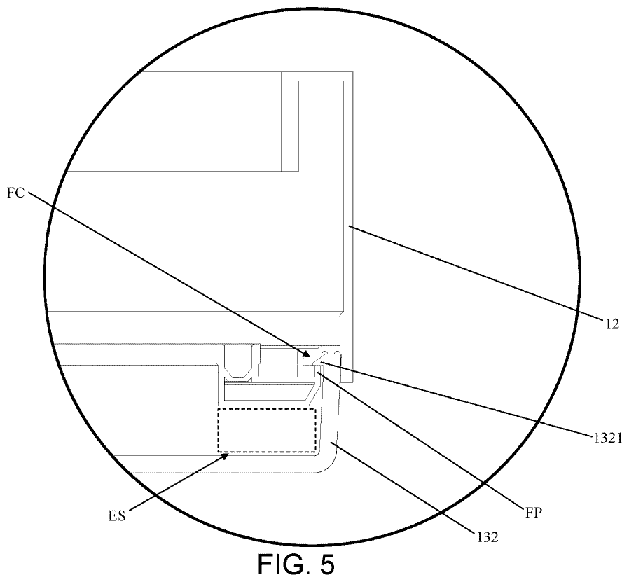

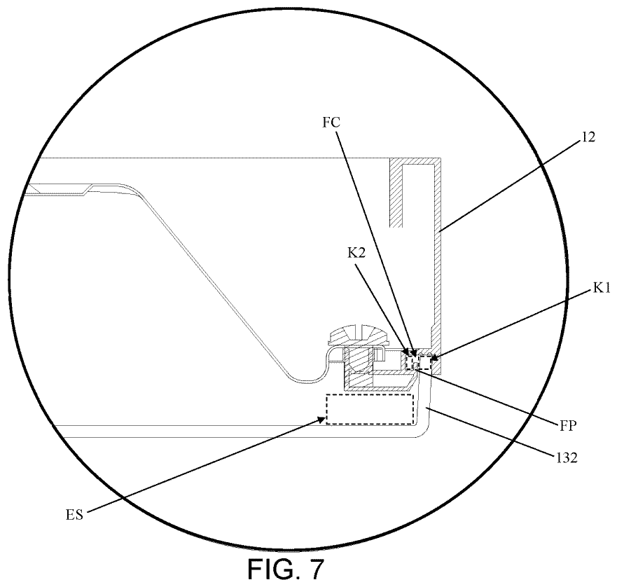

The light cover 132 has a light entrance L2 (shown as the area indicated by a two-dot chain line in FIG. 4), and the light entrance L2 is connected to the light exit L1. The area of the light entrance L2 is greater than the area of the light exit L1, forming an optical extension space ES between the periphery of the light cover 132 and the bottom of the frame body 12 (as shown in FIG. 5 and FIG. 7). In one embodiment, the light cover 132 is made of transparent or translucent material. In this embodiment, the light cover 132 may be made of plastic. In another embodiment, the light cover 132 may be made of glass.

Additionally, the panel light 1 further includes a power supply module 15. The power supply module 15 is disposed within the frame body 12. In this embodiment, the power supply module 15 may be a power supply. In another embodiment, the power supply module 15 may be a battery or other similar component.

As described above, since the area of the light entrance L2 of the light cover 132 is greater than the area of the light exit L1 of the back plate 131, the light generated by the light sources 1331 passes through the light exit L1 and enters the light entrance L2 of the light cover 132, then diffuses to both the front and side surfaces of the light cover 132.

Via this special optical structure design, the optical extension space ES is formed between the periphery of the light cover 132 and the bottom of the frame body 12. Therefore, the bottom surface of the light cover 132 forms a first light-emitting surface S1, while the side wall of the light cover 132 forms a second light-emitting surface S2 (as shown in FIG. 1). The first light-emitting surface S1 (the bottom surface of the light cover 132) serves as a front light-emitting surface, while the second light-emitting surface S2 (the side wall of the light cover 132) serves as a side light-emitting surface. Thus, the panel light 1 achieves both front light-emitting functionality and side light-emitting function, increasing the overall light-emitting area of the panel light 1 and significantly enhancing luminous flux. Consequently, the luminous efficacy of the panel light 1 can be effectively improved, substantially boosting the overall performance thereof. Additionally, the panel light 1 can achieve a frameless appearance for great visual effects.

Furthermore, in this embodiment, the panel light 1 features a special optical structure design that enables both front light-emitting function and side light-emitting function. Therefore, the luminous efficacy of the panel light 1 can be effectively improved, allowing it to reduce energy consumption while simultaneously lowering carbon emissions. Thus, the panel light 1 can truly meet energy-saving requirements.

The embodiment just exemplifies the present invention and is not intended to limit the scope of the present invention; any equivalent modification and variation according to the spirit of the present invention is to be also included within the scope of the following claims and their equivalents.

Please refer to FIG. 5, which is a partial enlargement view of the panel light in accordance with the first embodiment of the present invention. Please also refer to FIG. 1, FIG. 2, FIG. 3 and FIG. 4. FIG. 5 shows the enlarged view of the area A1 in FIG. 4. As shown in FIG. 5, the outer edge of the frame body 12 has a fixing channel FC and a fixing post FP.

The fixing post FP is disposed within the fixing channel FC, making the cross-section of the fixing channel FC U-shaped.

The inner wall of the light cover 132 has a plurality of protruding portions 1321.

The protruding portions 1321 are inserted in the fixing channel FC and engaged with the fixing post FP. The fixing channel FC, fixing post FP, and protruding portions 1321 may form a screw-free fastening structure. Through this fixing channel structure design, the light cover 132 can be mounted on the frame body 12 and fixed thereto via a simple screw-free fastening structure. Therefore, structural complexity of the panel light 1 can be significantly reduced, lowering the cost thereof. Simultaneously, the manufacturing process of the panel light 1 can be substantially simplified, reducing the production costs thereof. Thus, the panel light 1 can be more comprehensive in application.

Additionally, the outer edge of the frame body 12 of the panel light 1 may further have the fixing channel FC and fixing post FP. The fixing post FP is disposed within the fixing channel FC, making the cross-section of the fixing channel FC U-shaped. Via this fixing channel FC structure design, the light cover 132 can be mounted on the frame body 12 and fixed thereto via a simple screw-free fastening structure. Therefore, structural complexity of the panel light 1 can be significantly reduced, lowering the cost thereof. Simultaneously, the manufacturing process of the panel light 1 can be substantially simplified, reducing the production costs thereof. Thus, the panel light can be more comprehensive in application. The fixing channel can not only achieve a snap-fit fastening structure but also simultaneously function as both an adhesive groove and an adhesive overflow groove to realize an adhesive fastening structure. Therefore, the manufacturing process of the panel light can be more flexible to meet different application requirements. The light cover 132 can be mounted on the frame body 12 and fixed thereto via various fastening methods including but not limited to a snap-fit structure, ultrasonic welding, or an adhesive bonding structure. Therefore, the user can select suitable fastening methods according to actual needs, making the panel light 1 meet actual requirements.

The embodiment just exemplifies the present invention and is not intended to limit the scope of the present invention; any equivalent modification and variation according to the spirit of the present invention is to be also included within the scope of the following claims and their equivalents.

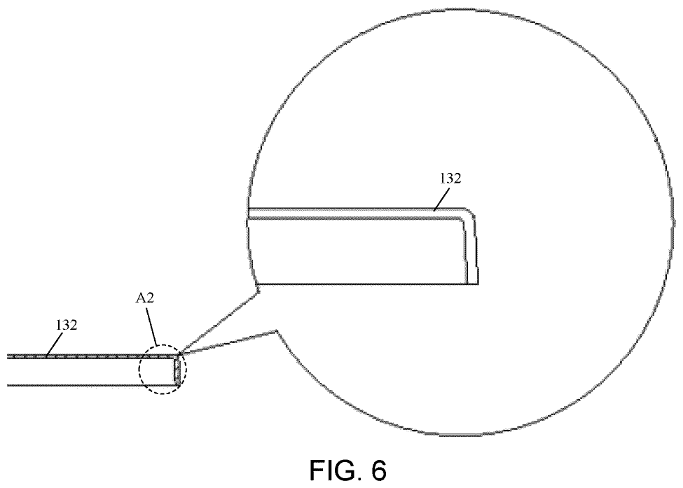

Please refer to FIG. 6, which is a first partial enlargement view of the panel light in accordance with a second embodiment of the present invention. Please also refer to FIG. 1, FIG. 2, FIG. 3 and FIG. 4. FIG. 6 shows the enlarged view of the area A2 of the light cover 132. As shown in FIG. 6, all four edges of the light cover 132 feature rounded corners. The difference between this embodiment and the previous embodiment is that the light cover 132 does not have the protruding portions 1321.

The embodiment just exemplifies the present invention and is not intended to limit the scope of the present invention; any equivalent modification and variation according to the spirit of the present invention is to be also included within the scope of the following claims and their equivalents.

Please refer to FIG. 7, which is a second partial enlargement view of the panel light in accordance with the second embodiment of the present invention. Please also refer to FIG. 1, FIG. 2, FIG. 3, FIG. 4 and FIG. 6. FIG. 7 shows the enlarged view of the area A1 in FIG. 4 (though the structure of the light cover 132 in this embodiment differs from the previous embodiment).

The portion of the fixing channel FC at the right side of the fixing post FP serves as an adhesive groove K1, while the portion of the fixing channel FC at the left side of the fixing post FP serves as an adhesive overflow groove K2. Thus, the fixing channel FC can simultaneously function as both the adhesive groove K1 and the adhesive overflow groove K2.

The user can fill the adhesive groove K1 of the fixing channel FC with adhesive, then insert the outer edge of the light cover 132 into the adhesive groove K1 of the fixing channel FC. In this manner, the outer edge of the light cover 132 can be fixed in the adhesive groove K1 of the fixing channel FC by the adhesive. Excess adhesive will then be pushed into the adhesive overflow groove K2 without overflowing from the fixing channel FC.

In another embodiment, the outer edge of the light cover 132 may alternatively be fixed in the fixing channel FC via ultrasonic welding or other similar fastening methods.

As described above, the outer edge of the frame body 12 of the panel light 1 has the fixing channel FC and fixing post FP. The fixing post FP is disposed within the fixing channel FC, making the cross-section of the fixing channel FC U-shaped. Via this fixing channel FC structure design, the fixing channel can not only achieve a snap-fit fastening structure but also simultaneously function as both the adhesive groove K1 and the adhesive overflow groove K2 to realize an adhesive fastening structure. Therefore, the manufacturing process of the panel light 1 can be more flexible to meet different application requirements.

Furthermore, according to embodiments of the present invention, the outer edge of the frame body 12 of the panel light 1 has the fixing channel FC and fixing post FP. The fixing post FP is disposed within the fixing channel FC, making the cross-section of the fixing channel FC U-shaped. Via this fixing channel FC structure design, the light cover 132 can be mounted on the frame body 12 and fixed thereto via various fastening methods including but not limited to a snap-fit structure, ultrasonic welding, or an adhesive bonding structure. Therefore, the user can select suitable fastening methods according to actual needs, making the panel light 1 conform to actual requirements.

Similarly, the panel light 1 of this embodiment also features the special optical structure design. Via this optical structure design, the bottom surface of the light cover 132 forms a first light-emitting surface S1 while the side wall forms a second light-emitting surface S2. The first light-emitting surface S1 serves as a front light-emitting surface, and the second light-emitting surface S2 serves as a side light-emitting surface. Thus, the panel light 1 achieves both front light-emitting function and side light-emitting function, increasing the overall light-emitting area and significantly enhancing luminous flux thereof. Consequently, the luminous efficacy of the panel light 1 can be effectively improved, substantially boosting the overall performance thereof. Additionally, the panel light 1 can achieve a frameless appearance for great visual effects.

The panel light 1 of this embodiment is rectangular. In another embodiment, the panel light 1 may alternatively be circular or polygonal (such as pentagonal, hexagonal, etc.). The panel light 1 is not limited to the shapes described in the above embodiments. Panel lights 1 of different shapes can all adopt the aforementioned optical structure design to achieve the same effects.

The embodiment just exemplifies the present invention and is not intended to limit the scope of the present invention; any equivalent modification and variation according to the spirit of the present invention is to be also included within the scope of the following claims and their equivalents.

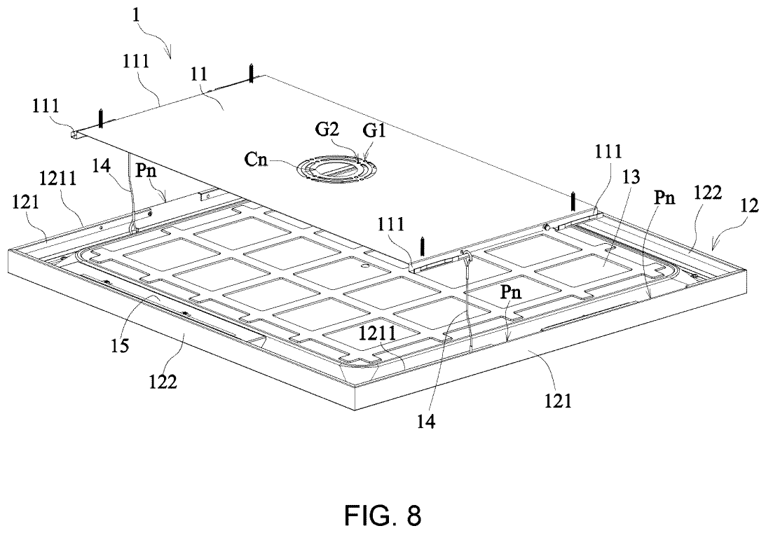

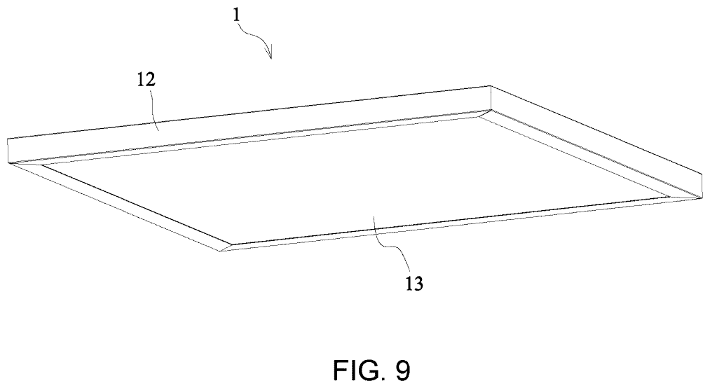

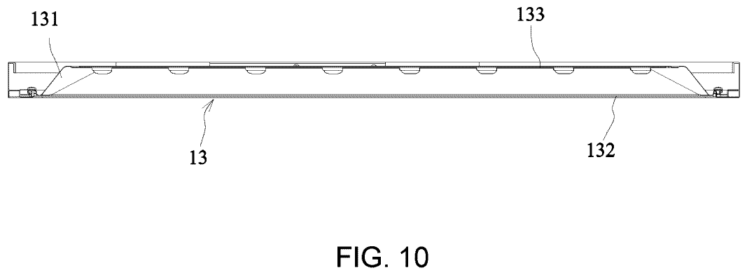

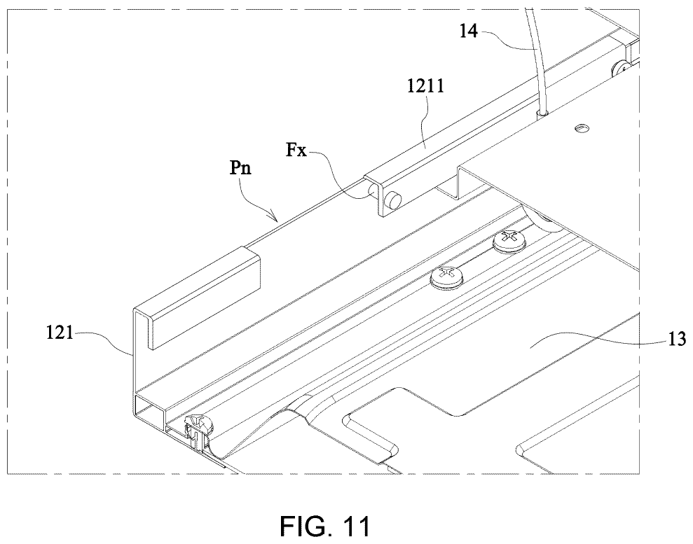

Please refer to FIG. 8, FIG. 9, FIG. 10, and FIG. 11. FIG. 8 is an exploded view of a panel light in accordance with a third embodiment of the present invention. FIG. 9 is a perspective view of the panel light in accordance with the third embodiment of the present invention. FIG. 10 is a sectional view of a lamp body of the panel light in accordance with the third embodiment of the present invention. FIG. 11 is a partial enlargement view of the panel light in accordance with the third embodiment of the present invention. As shown in FIG. 8, FIG. 9, FIG. 10, and FIG. 11, the panel light 1 includes a carrier plate 11, a frame body 12, a lamp body 13, two safety ropes 14, and a power supply module 15.

The carrier plate 11 has a plurality of fixing portions 111 disposed at the two ends of the carrier plate 11, and the fixing portions 111 are U-shaped. There are at least two fixing portions 111. The carrier plate 11 also has a wiring hole Cn and a plurality of fixing holes arranged around the wiring hole Cn. The fixing holes include four first fixing holes G1 and four second fixing holes G2. The numbers of the first fixing holes G1 and the second fixing holes G2 can be adjusted as needed. In this embodiment, there are four fixing portions 111. In another embodiment, the number of fixing portions 111 can exceed four and can be adjusted based on actual needs. In one embodiment, the carrier plate 11 can be made of metal, such as aluminum, iron, copper, or stainless steel. In another embodiment, the carrier plate 11 can be made of plastic.

The frame body 12 includes two first frame strips 121 and two second frame strips 122. These two first frame strips 121 and two second frame strips 122 are spliced with each other to form the frame body 12. The two first frame strips 121 are arranged opposite to each other and correspond to the four fixing portions 111. Each first frame strip 121 has an L-shaped hook portion 1211, such that the cross-section of the first frame strip 121 is inverted U-shaped. At least one first frame strip 121 includes a locking member Fx fixed to the L-shaped hook portion 1211 of the first frame strip 121. In one embodiment, the frame body 12 can be made of metal, such as aluminum, iron, copper, or stainless steel. In another embodiment, the frame body 12 can be made of plastic. The L-shaped hook portion 1211 has an opening Pn, such that each fixing portion 111 can be engaged with the L-shaped hook portion 1211 of the first frame strip 121 corresponding thereto via the opening Pn of the L-shaped hook portion 1211. In another embodiment, each first frame strip 121 has a locking member Fx.

The lamp body 13 is disposed within the frame body 12. The lamp body 13 includes a back plate 131, a light cover 132, and a light source board 133. The light source board 133 is installed on the back plate 131. The light cover 132 is attached to the back plate 131 and covers the light source board 133. In one embodiment, the light source board 133 includes a circuit board 1332 and a plurality of light sources 1331 (as shown in FIG. 1 and FIG. 4). In another embodiment, the light source board 133 can be replaced by light bulbs, fluorescent tubes, or other currently available light sources.

The power supply module 15 is disposed within the frame body 12 and is electrically connected to the light source board 133. In one embodiment, the power supply module 15 includes rectifier circuits, filter circuits, LED drivers, and similar components. In another embodiment, the power supply module 15 can be a power supplier for light bulbs or fluorescent tubes.

The two safety ropes 14 are corresponding to the two first frame strips 121, and also corresponding to the four fixing portions 111. The two ends of each safety rope 14 are fixed to the corresponding first frame strip 121 and fixing portion 111.

The embodiment just exemplifies the present invention and is not intended to limit the scope of the present invention; any equivalent modification and variation according to the spirit of the present invention is to be also included within the scope of the following claims and their equivalents.

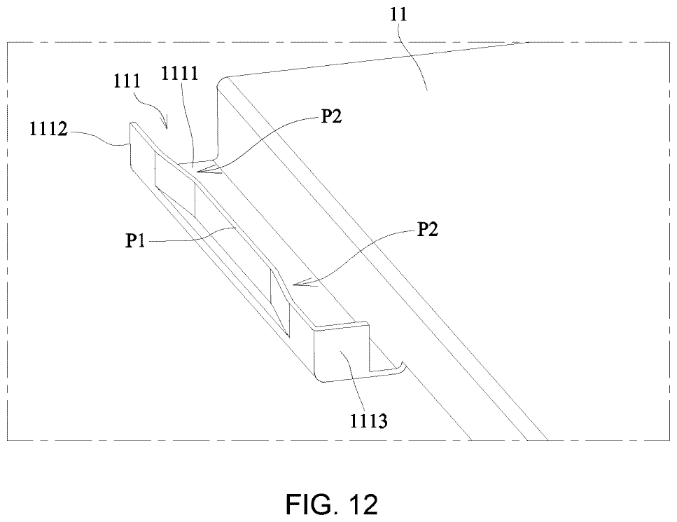

Please refer to FIG. 12, which is a partial enlargement view of a carrier plate of the panel light in accordance with the third embodiment of the present invention. As shown in FIG. 5, each fixing portion 111 of the carrier plate 11 includes an L-shaped supporting portion 1111 and a wall portion 1112. The wall portion 1112 is connected to the L-shaped supporting portion 1111, and the L-shaped supporting portion 1111 is connected to the carrier plate 11. At least one fixing portion 111 includes a blocking plate 1113, which is disposed at one end of the fixing portion 111. In this embodiment, the blocking plate 1113 is disposed on the wall portion 1112 of the fixing portion 111. In another embodiment, the blocking plate 1113 may also be disposed on the L-shaped supporting portion 1111 of the fixing portion 111. The wall portion 1112 includes a protruding portion P1 and two recessed portions P2. The protruding portion P1 extends in the direction toward the carrier plate 11, and the two recessed portions P2 are disposed on the sides of the protruding portion P1.

The embodiment just exemplifies the present invention and is not intended to limit the scope of the present invention; any equivalent modification and variation according to the spirit of the present invention is to be also included within the scope of the following claims and their equivalents.

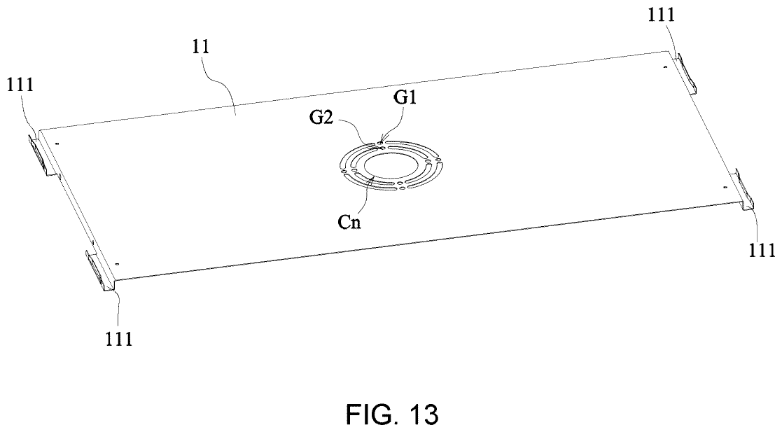

Please refer to FIG. 13, which is a perspective view of the carrier plate of the panel light in accordance with the third embodiment of the present invention. As shown in FIG. 6, the carrier plate 11 has a wiring hole Cn and a plurality of fixing holes arranged around the wiring hole Cn. The fixing holes include four first fixing holes G1 and four second fixing holes G2. The numbers of the first fixing holes G1 and second fixing holes G2 can be adjusted as needed.

The centers of the four first fixing holes G1 can be connected to form a first circle, while the centers of the four second fixing holes G2 can be connected to form a second circle. The diameter of the first circle is different from that of the second circle. In this embodiment, the diameter of the first circle is greater than that of the second circle. In another embodiment, the diameter of the first circle is less than that of the second circle.

The embodiment just exemplifies the present invention and is not intended to limit the scope of the present invention; any equivalent modification and variation according to the spirit of the present invention is to be also included within the scope of the following claims and their equivalents.

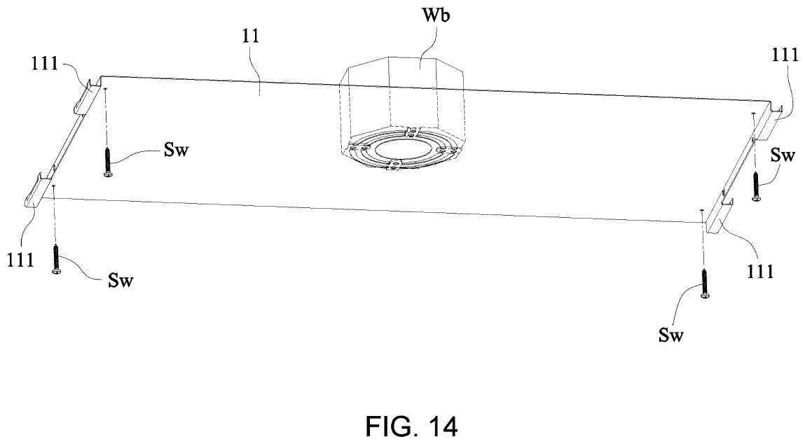

Please refer to FIG. 14, which a schematic view of a combination of the carrier plate and a junction box of the panel light in accordance with the third embodiment of the present invention. As shown in FIG. 7, the carrier plate 11 can be fixed to the ceiling via a plurality of fasteners Sw (e.g., screws, nails, etc.). The panel light 1 also includes a junction box Wb, which can also be fixed to the carrier plate 11 via a plurality of fasteners and the aforementioned fixing holes. The junction box Wb is disposed on the carrier plate 11 at the location corresponding to the wiring hole Cn, and the junction box Wb can be fixed to the carrier plate 11 via the four first fixing holes G1 or the second fixing holes G2. In this way, the wiring hole Cn can communicate with the internal space of the junction box Wb. The first fixing holes G1 can be used to secure larger junction boxes Wb, while the second fixing holes G2 can be used to secure smaller junction boxes Wb. In this embodiment, the number of fasteners Sw is four. In another embodiment, the number of fasteners Sw can be adjusted based on actual needs.

Through the above-mentioned junction box matching structure, junction boxes Wb of different sizes can be secured to the carrier plate 11. As a result, the panel light 1 can be compatible with junction boxes Wb of various sizes, so the practicality of the panel light 1 can be enhanced.

The embodiment just exemplifies the present invention and is not intended to limit the scope of the present invention; any equivalent modification and variation according to the spirit of the present invention is to be also included within the scope of the following claims and their equivalents.

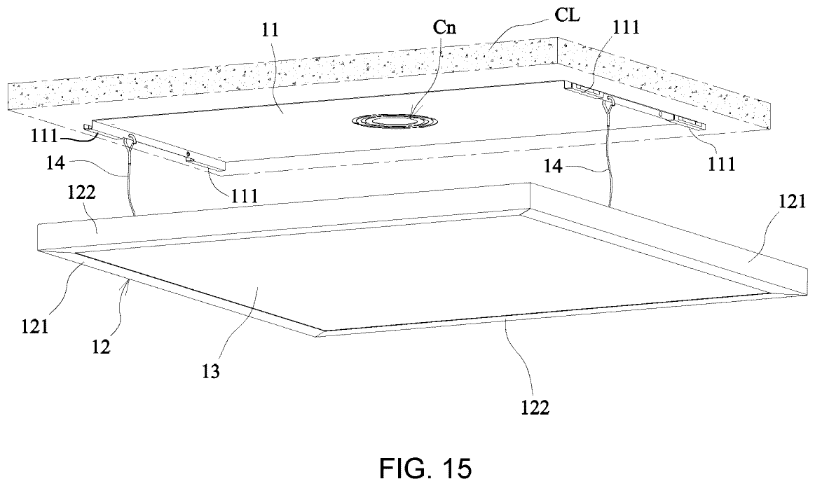

Please refer to FIG. 15, which is a first schematic view of an installation process of the panel light in accordance with the third embodiment of the present invention. As shown in FIG. 8, the user can first fix the carrier plate 11 to the ceiling CL via several fasteners Sw and align the wiring hole Cn of the carrier plate 11 with the junction box Wb. The user can then secure the junction box Wb to the carrier plate 11. The frame body 12 can be suspended from the carrier plate 11 via the two safety ropes 14, such that the frame body 12 can remain in a suspended state at a distance from the carrier plate 11. At this point, the user can independently perform a wiring operation. This temporary load-bearing structural design significantly simplifies the installation process with a view to effectively reducing labor costs.

The embodiment just exemplifies the present invention and is not intended to limit the scope of the present invention; any equivalent modification and variation according to the spirit of the present invention is to be also included within the scope of the following claims and their equivalents.

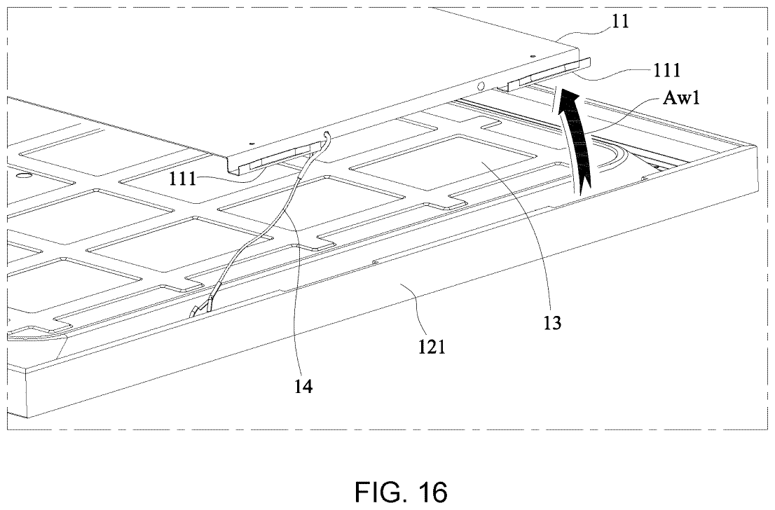

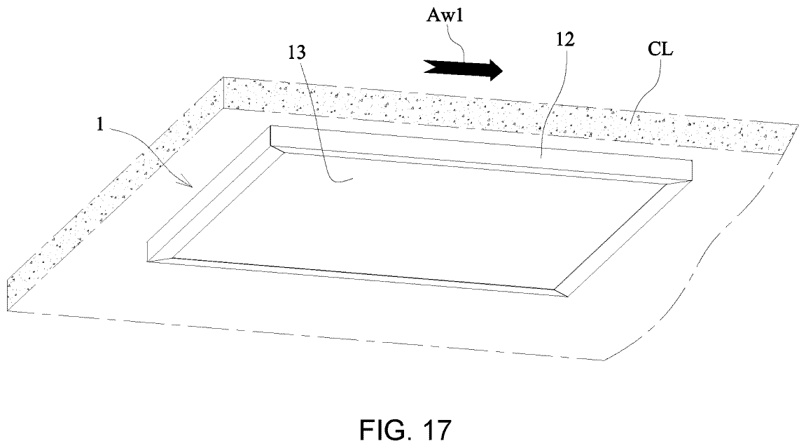

Please refer to FIG. 16 and FIG. 17. FIG. 16 is a second schematic view of the installation process of the panel light in accordance with the third embodiment of the present invention. FIG. 17 is a third schematic view of the installation process of the panel light in accordance with the third embodiment of the present invention. As shown in FIG. 16, after completing the wiring operation, the user can move the frame body 12 in the direction of the arrow Aw1 to make the frame body 12 approach the carrier plate 11 and tighten the two safety ropes 14. The four fixing portions 111 then enter the openings Pn of the L-shaped hook portions 1211 of the two first frame strips 121. At this point, the two safety ropes 14 are in taut state.

The embodiment just exemplifies the present invention and is not intended to limit the scope of the present invention; any equivalent modification and variation according to the spirit of the present invention is to be also included within the scope of the following claims and their equivalents.

As shown in FIG. 17, the user can then move the frame body 12 horizontally in the direction of the arrow Aw2 to make the frame body 12 move toward the carrier plate 11. The L-shaped hook portions 1211 of the two first frame strips 121 are then engaged with the four fixing portions 111 of the carrier plate 11, thereby securing the frame body 12 to the carrier plate 11.

As previously stated, the panel light 1 has a special automatic alignment structure. When the fixing portions 111 of the carrier plate 11 are disposed in the openings Pn of the L-shaped hook portions 1211 of the two first frame strips 121, the two safety ropes 14 are tightened. Therefore, when the frame body 12 is suspended, the user can move the frame body 12 to tighten the two safety ropes 14 and align the four fixing portions with the openings Pn of the two first frame strips. The user can then move the frame body 12 horizontally to make the frame body 12 be engaged with the carrier plate 11. Accordingly, the user can independently perform an assembly operation, further simplifying the installation process and reducing labor costs.

The embodiment just exemplifies the present invention and is not intended to limit the scope of the present invention; any equivalent modification and variation according to the spirit of the present invention is to be also included within the scope of the following claims and their equivalents.

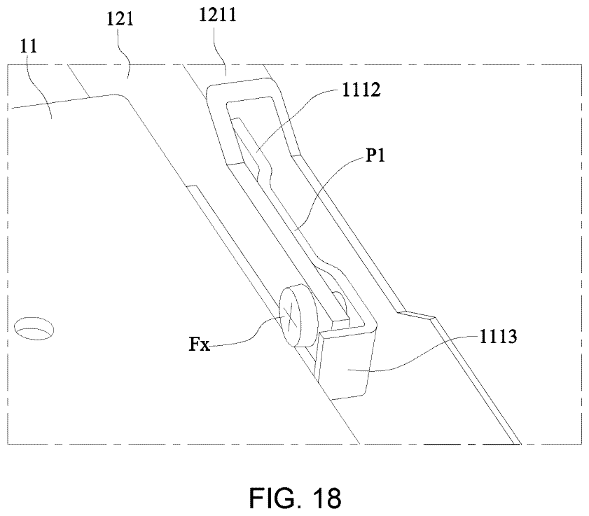

Please refer to FIG. 18, which is a fourth schematic view of the installation process of the panel light in accordance with the third embodiment of the present invention. Please also refer to FIG. 11 and FIG. 12. As shown in FIG. 18, when the frame body 12 moves toward the carrier plate 11, the locking member Fx fixed on the L-shaped hook portion 1211 of the first frame strip 121 first enters the recessed portion P2 on one side of the wall portion 1112 of the corresponding fixing portion 111 (the recessed portion P2 is located on the side away from the blocking plate 113). The locking member Fx then passes through the protruding portion P1 and is compressed by the protruding portion P1. The locking member Fx subsequently enters the recessed portion P2 on the other side of the wall portion 1112 of the corresponding fixing portion 111 (the recessed portion P2 is located near the blocking plate 113). Thus, the protruding portion P1 provides a position-limiting function to prevent the locking member Fx from detaching from the recessed portion P2. Meanwhile, the blocking plate 113 also prevents the locking member Fx from disengaging from the fixing portion 111.

This automatic locking structure ensures that after the frame body 12 and the carrier plate 11 are engaged with each other, the two first frame strips 121 of the frame body 12 and the fixing portions 111 of the carrier plate 11 are securely locked to prevent separation. This automatic locking structure effectively enhances the structural stability and safety of the panel light 1.

In addition, in this embodiment, the U-shaped mounting structure formed by the U-shaped fixing portions 111 and the inverted U-shaped first frame strips 121 allows the carrier plate 11 to be combined with the frame body 12 through a simple structural design, significantly reducing the cost of the panel light 1. As a result, the panel light 1 meets the requirements of various applications.

Further, in this embodiment, the panel light 1 has a U-shaped installation structure without mounting holes, such that the carrier plate 11 can be combined with the frame body 12 through a simple structural design and remain concealed within the frame body 12. This results in a more minimalist and aesthetically pleasing appearance for the panel light 1. Thus, the panel light 1 effectively enhances the interior space of buildings, providing users with an excellent experience.

The embodiment just exemplifies the present invention and is not intended to limit the scope of the present invention; any equivalent modification and variation according to the spirit of the present invention is to be also included within the scope of the following claims and their equivalents.

It is worthy to point out that some currently available panel lights are mounted on the ceiling via a ceiling-mounted frame. However, such mounting structures are bulky and heavy, resulting in low installation efficiency and negatively affecting the appearance of the panel light. Besides, the high cost of these mounting structures significantly limits the application of panel lights. Some other currently available panel lights can be installed on the ceiling using a mounting structure that includes a carrier plate and hooks. While this mounting structure improves the appearance compared to ceiling-mounted lights, the installation process is relatively complex, leading to low installation efficiency. Furthermore, this mounting structure lacks sufficient safety. Additionally, some currently available panel lights can be installed on the ceiling via a metal frame with multiple mounting holes. However, this mounting structure requires several people to complete the installation process, thereby increasing labor costs. Moreover, this structure also affects the appearance of the panel lights. By contrast, according to one embodiment of the present invention, the panel light includes a carrier plate, a frame body and two safety ropes. The carrier plate has two fixing portions disposed at the two ends thereof. The frame body has two first frame strips and two second frame strips spliced with each other. The first frame strips are arranged opposite to each other and corresponding to the fixing portions respectively, and the second frame strips are arranged opposite to each other. Each first frame strip has an L-shaped hook portion, such that the cross-section of the first frame strip is inverted U-shaped, and the L-shaped hook portion has an opening. The safety ropes are corresponding to the first frame strips respectively and corresponding to the fixing portions respectively. The two ends of each safety rope are fixed to the first frame strip and the fixing portion corresponding thereto. When the fixing portions of the carrier plate are disposed at the openings of the L-shaped hook portions of the first frame strips respectively, the safety ropes are in taut state. Each fixing portions is engaged with the L-shaped hook portion of the first frame strip corresponding thereto via the opening of the L-shaped hook portion. The user can first fix the carrier plate to the ceiling and hang the frame body via the two safety ropes, such that the frame body to remain suspended at a distance from the carrier plate. At this point, the user can independently perform a wiring operation, and after completing the wiring operation, assemble the frame body with the carrier plate. This temporary load-bearing structural design significantly simplifies the installation process, so labor costs can be effectively reduced.

According to one embodiment of the present invention, the panel light also has a special automatic alignment structure. When the fixing portions of the carrier plate are disposed at the openings of the L-shaped hook portions of the two first frame strips respectively, the safety ropes are in taut state. Therefore, when the frame body is suspended, the user can move the frame body to ensure that the two safety ropes are taut, such that the fixing portions can enter the openings of the L-shaped hook portions of the two first frame strips. The user can then move the frame body horizontally to engage which with the carrier plate. Therefore, the user can independently perform the assembly process so as to further simplify installation and reducing labor costs.

Also, according to one embodiment of the present invention, the cross-sections of the two first frame strips of the panel light are inverted U-shaped, while the two fixing portions of the carrier plate are U-shaped. The U-shaped installation structure formed by the U-shaped fixing portions and the inverted U-shaped first frame strips allows the carrier plate to combine with the frame body through a simple structural design, which can significantly reduce the cost of the panel light. Thus, the panel light can meet the requirements of various applications.

Further, according to one embodiment of the present invention, the panel light has a special automatic locking structure. Each fixing portion includes an L-shaped supporting portion and a wall portion. The wall portion is connected to the L-shaped supporting portion, and the L-shaped supporting portion is connected to the carrier plate. The wall portion includes a protruding portion and two recessed portions. The protruding portion extends in the direction toward the carrier plate, and the two recessed portions are disposed on the two sides of the protruding portion. Each first frame strip also includes a locking member. The locking member is fixed to the L-shaped hook portion of the first frame strip and engaged with one of the recessed portions of the wall portion of the corresponding fixing portion. This automatic locking structure provides an automatic locking function after the frame body and carrier plate are engaged with each other in order to secure the two first frame strips of the frame body to the fixing portions of the carrier plate. This automatic locking structure prevents the frame body from separating from the carrier plate and effectively enhances the structural stability and safety of the panel light.

Moreover, according to one embodiment of the present invention, the panel light has a junction box matching structure. Via this junction box matching structure, the panel light can accommodate junction boxes of different sizes, such that the panel light can be more flexible in use. Consequently, the panel light achieves greater practicality.

Furthermore, according to one embodiment of the present invention, the panel light features a U-shaped installation structure without mounting holes, enabling the carrier plate to combine with the frame body through a simple structural design and remain concealed within the frame body. As a result, the panel light achieves a more minimalistic and aesthetically pleasing appearance. This effectively enhances the interior space of buildings, providing users with an excellent user experience. As set forth above, the panel light according to the embodiments of the present invention can achieve great technical effects.

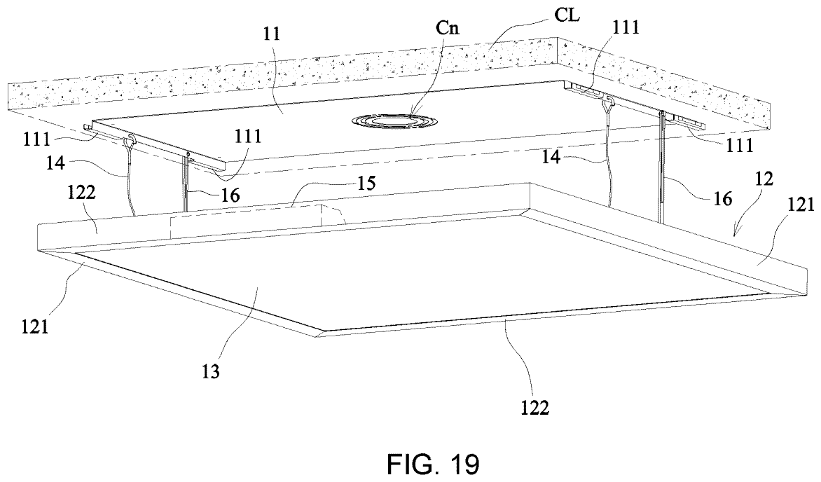

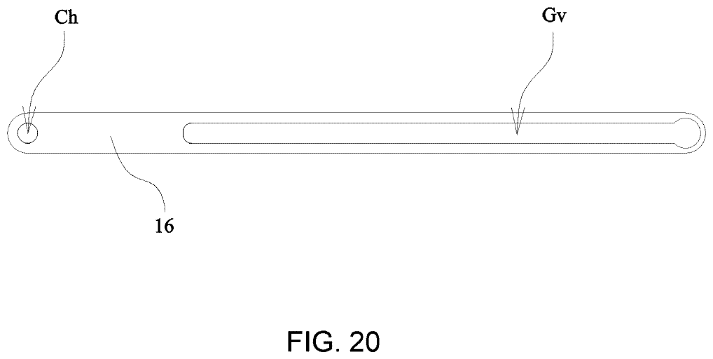

Please refer to FIG. 19 and FIG. 20. FIG. 19 is an exploded view of a panel light in accordance with a fourth embodiment of the present invention. FIG. 20 is a front view of a supporting plate of the panel light in accordance with the fourth embodiment of the present invention. Please also refer to FIG. 11, FIG. 12, FIG. 16, FIG. 17, and FIG. 19.

As shown in FIG. 19 and FIG. 20, the panel light 1 includes a carrier plate 11, a frame body 12, a lamp body 13, two safety ropes 14, and a power supply module 15. The above elements are the same as those in the previous embodiment and will not be described herein.

The difference between this embodiment and the previous embodiments is that the panel light 1 in this embodiment further includes two supporting plates 16. The two supporting plates 16 are corresponding to the first frame strips 121 of the frame body 12 respectively, and also corresponding to the fixing portions 111 of the carrier plate 11 respectively. The two ends of each supporting plate 16 are fixed to the corresponding first frame strip 121 and fixing portion 111. One end of each supporting plate 16 has a groove Gv, while the other end thereof has a connection hole Ch. The supporting plate 16 is fixed to the corresponding fixing portion 111 via the groove Gv and to the corresponding first frame strip 121 via the connection hole Ch.

When the frame body 12 is in suspended state, the user can move the frame body 12. At this time, the two supporting plates 16 provide automatic guiding and alignment functions, such that the four fixing portions can enter the openings Pn of the L-shaped hook portions 1211 of the two first frame strips 121. When the four fixing portions of the carrier plate 11 are disposed at the openings Pn of the L-shaped hook portions 1211 of the two first frame strips 121, the two supporting plates 16 become parallel to the frame body 12 and the carrier plate 11. The user can then move the frame body 12 horizontally, such that the frame body 12 can be engaged with the carrier plate 11.

As described above, the supporting plates 16 can serve as temporary load-bearing structures while also providing automatic alignment and guiding functions. Through the structural design of the supporting plates 16, the panel light 1 can offer more precise automatic guiding and alignment functions, which can simplify the installation process and reducing labor costs.

The embodiment just exemplifies the present invention and is not intended to limit the scope of the present invention; any equivalent modification and variation according to the spirit of the present invention is to be also included within the scope of the following claims and their equivalents.

According to another embodiment of the present invention, the panel light 1 includes a carrier plate 11 and a frame body 12. The carrier plate 11 has two fixing portions 111 located at the two ends of the carrier plate 11. Each fixing portion 111 is U-shaped and includes an L-shaped supporting portion 1111 and a wall portion 1112 connected to each other. The L-shaped supporting portion 1111 is connected to the carrier plate 11. The wall portion 1112 includes a protruding portion P1 and two recessed portions P2. The protruding portion P1 extends in the direction toward the carrier plate 11, and the two recessed portions P2 are disposed on the two sides of the protruding portion P1. The top end of the protruding portion P1 is flat, while the two sides thereof are slanted. The frame body 12 includes two first frame strips 121 and two second frame strips 122 spliced with each other. The two first frame strips 121 are arranged opposite to each other and corresponding to the two fixing portions 111. The second frame strips 122 are also arranged opposite to each other. Each first frame strip 121 has an L-shaped hook portion 1211 and a locking member Fx, such that the cross-section of the first frame strip 121 is inverted U-shaped. The L-shaped hook portion 1211 has an opening Pn. The locking member Fx is fixed to the L-shaped hook portion 1211 and engaged with one of the recessed portions P2 of the wall portion 1112 of the corresponding fixing portion 111.

According to still another embodiment of the present invention, the panel light 1 includes a carrier plate 11, a frame body 12, and two supporting plates 16. The carrier plate 11 has two fixing portions 111 disposed at the two ends of the carrier plate 11. The fixing portions 111 are U-shaped. The frame body 12 includes two first frame strips 121 and two second frame strips 122 spliced with each other. The two first frame strips 121 are arranged opposite to each other and corresponding to the two fixing portions 111. The two second frame strips 122 are also arranged opposite to each other. Each first frame strip 121 has an L-shaped hook portion 1211, such that the cross-section of the first frame strip 121 is inverted U-shaped. The L-shaped hook portion 1211 has an opening Pn. The two supporting plates 16 are corresponding to the two first frame strips 121 respectively, and also corresponding to the two fixing portions 111 respectively. The two ends of each supporting plate 16 are fixed to the corresponding first frame strip 121 and fixing portion 111. When the two fixing portions 111 of the carrier plate 11 are disposed at the openings Pn of the L-shaped hook portions 1211 of the two first frame strips 121, the two supporting plates 16 become parallel to the frame body 12 and the carrier plate 11. Each fixing portion 111 is engaged with the L-shaped hook portion 1211 of the corresponding first frame strip 121 via the opening Pn of the L-shaped hook portion 1211.

According to yet another embodiment of the present invention, the panel light 1 includes a carrier plate 11, a frame body 12, and a junction box Wb. The carrier plate 11 has two fixing portions 111 disposed at the two ends of the carrier plate 11, a wiring hole Cn, and a plurality of fixing holes. The fixing portions 111 are U-shaped. The fixing holes are arranged around the wiring hole Cn and include a plurality of first fixing holes G1 and a plurality of second fixing holes G2. The centers of the multiple first fixing holes G1 can be connected to form a first circle, while the centers of the multiple second fixing holes G2 can be connected to form a second circle. The diameter of the first circle is different from that of the second circle. The frame body 12 includes two first frame strips 121 and two second frame strips 122 spliced with each other. The two first frame strips 121 are arranged opposite to each other and corresponding to the two fixing portions 111. The two second frame strips 122 are also arranged opposite to each other. Each first frame strip 121 has an L-shaped hook portion 1211, such that the cross-section of the first frame strip 121 is inverted U-shaped. The L-shaped hook portion 1211 has an opening Pn. The junction box Wb is disposed on the carrier plate 11 at a location corresponding to the wiring hole Cn. The junction box is fixed to the carrier plate 11 via the first fixing holes G1 or the second fixing holes G2. The wiring hole Cn communicates with the internal space of the junction box Wb. Each fixing portion 111 is engaged with the L-shaped hook portion 1211 of the corresponding first frame strip 121 via the opening Pn of the L-shaped hook portion 1211.

To sum up, according to one embodiment of the present invention, the panel light includes a frame body, a back plate, a plurality of light sources and a light cover. The frame body has an opening. The back plate is disposed within the frame body via the opening, and the back plate has a light exit. The light sources are disposed within the back plate via the light exit. The light cover is disposed on the frame body and covers the light sources. The light cover has a light entrance connected to the light exit. The area of the light entrance is greater than the area of the light exit. Via this special optical structure design, a bottom surface of the light cover forms a first light-emitting surface while a side wall of the light cover forms a second light-emitting surface. The first light-emitting surface serves as a front light-emitting surface, and the second light-emitting surface serves as a side light-emitting surface. Thus, the panel light not only has front light-emitting function but also side light-emitting function, increasing the overall light-emitting area of the panel light and significantly enhancing luminous flux. Consequently, the luminous efficacy of the panel light can be effectively improved, substantially boosting the overall performance of the panel light. Additionally, the panel light can achieve a frameless appearance for great visual effects.

Also, according to one embodiment of the present invention, the panel light has a special optical structure design that enables both front light-emitting function and side light-emitting function. Therefore, the luminous efficacy of the panel light can be effectively improved, allowing the panel light to reduce energy consumption while simultaneously lowering carbon emissions. Thus, the panel light can truly meet energy-saving requirements.

Further, according to one embodiment of the present invention, the outer edge of the frame body of the panel light has a fixing channel and a fixing post. The fixing post is disposed within the fixing channel such that the cross-section of the fixing channel is U-shaped. Via this fixing channel structure design, the light cover can be mounted on the frame body and fixed thereto via a simple screw-free fastening structure. Consequently, structural complexity of the panel light can be significantly reduced, lowering the cost thereof. Simultaneously, the manufacturing process of the panel light can be substantially simplified, reducing the production costs thereof. Therefore, the panel light can be more comprehensive in application.

Moreover, according to one embodiment of the present invention, the outer edge of the frame body of the panel light has the fixing channel and the fixing post. The fixing post is disposed within the fixing channel such that the cross-section of the fixing channel is U-shaped. Via this fixing channel structure design, the fixing channel can not only achieve a snap-fit fastening structure but also simultaneously function as both an adhesive groove and an adhesive overflow groove to realize an adhesive fastening structure. Thus, the manufacturing process of the panel light can be more flexible to meet different application requirements.

Furthermore, according to one embodiment of the present invention, the outer edge of the frame body of the panel light has the fixing channel and the fixing post. The fixing post is disposed within the fixing channel such that the cross-section of the fixing channel is U-shaped. Via this fixing channel structure design, the light cover can be mounted on the frame body and fixed thereto via various fastening methods including but not limited to a snap-fit structure, ultrasonic welding, or an adhesive bonding structure. Therefore, the user can select suitable fastening methods according to actual needs, making the panel light better conform to actual requirements.

It will be apparent to those skilled in the art that various modifications and variations can be made to the disclosed embodiments. It is intended that the specification and examples be considered as exemplary only, with a true scope of the present invention being indicated by the following claims and their equivalents.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A panel light, comprising:
a frame body, having an opening;
a back plate disposed within the frame body via the opening, wherein the back plate has a light exit;
a plurality of light sources disposed within the back plate via the light exit; and
a light cover disposed on the frame body and covering the light sources, wherein the light cover has a light entrance connected to the light exit;
wherein an area of the light entrance is greater than an area of the light exit.

2. The panel light as claimed in claim 1, wherein an outer edge of the frame body has a fixing channel and a fixing post disposed within the fixing channel, whereby a cross-section of the fixing channel is U-shaped.

3. The panel light as claimed in claim 2, wherein an inner wall of the light cover has a plurality of protruding portions inserted into the fixing channel and engaged with the fixing post.

4. The panel light as claimed in claim 2, wherein the fixing channel has an adhesive, an outer edge of the light cover is inserted into the fixing channel and fixed in the fixing channel by the adhesive.

5. The panel light as claimed in claim 2, wherein an outer edge of the light cover is fixed in the fixing channel by ultrasonic welding.

6. The panel light as claimed in claim 1, wherein the back plate is fixed in the frame body by a plurality of fixation elements.

7. The panel light as claimed in claim 1, wherein a bottom surface of the light cover forms a first light-emitting surface, while a side wall of the light cover forms a second light-emitting surface.

8. The panel light as claimed in claim 1, further comprising a power supply module disposed within the frame body.

9. The panel light as claimed in claim 1, further comprising a carrier plate and two safety ropes, wherein the carrier plate has two fixing portions disposed at two ends thereof, wherein the frame body has two first frame strips and two second frame strips spliced with each other, and the first frame strips are arranged opposite to each other and corresponding to the fixing portions respectively, and the second frame strips are arranged opposite to each other, and each of the first frame strips has an L-shaped hook portion, whereby a cross-section of the first frame strip is inverted U-shaped, and the L-shaped hook portion has an opening, wherein the safety ropes are corresponding to the first frame strips respectively and corresponding to the fixing portions respectively, and two ends of each of the safety ropes are fixed to the first frame strip and the fixing portion corresponding thereto, whereby when the fixing portions of the carrier plate are disposed at the openings of the L-shaped hook portions of the first frame strips respectively, the safety ropes are in taut state, wherein each of the fixing portions is engaged with the L-shaped hook portion of the first frame strip corresponding thereto via the opening of the L-shaped hook portion.

10. The panel light as claimed in claim 9, wherein the fixing portions are U-shaped.

11. The panel light as claimed in claim 9, wherein one of the fixing portions has a blocking plate disposed at one end thereof.

12. The panel light as claimed in claim 9, wherein each of the fixing portions comprises an L-shaped supporting portion and a wall portion connected to the L-shaped supporting portion, and the L-shaped supporting portion is connected to the carrier plate.

13. The panel light as claimed in claim 12, wherein the wall portion has a protruding portion extending in a direction toward the carrier plate, and two recessed portions disposed on two sides of the protruding portion.

14. The panel light as claimed in claim 13, wherein each of the first frame strips further comprises a locking member fixed to the L-shaped hook portion thereof and engaged with one of the recessed portions of the wall portion of the fixing portion corresponding thereto.

15. The panel light as claimed in claim 9, further comprising two supporting plates corresponding to the two first frame strips respectively and corresponding to the two fixing portions respectively, wherein two ends of each of the supporting plates are fixed to the first frame strip and the fixing portion corresponding thereto.

16. The panel light as claimed in claim 15, wherein one end of each of the supporting plates has a groove, and the supporting plate is fixed to the fixing portion corresponding thereto via the groove.

17. The panel light as claimed in claim 1, further comprising a lamp body disposed within the frame body.
